(19) United States
(12) Patent Application Publication
(10) Pub. No.: US 2006/0172588 A1
(43) Pub. Date: Aug. 3, 2006

(54) Flexible flat cable assembly and electronic device utilizing the same

(75) Inventor: Shu Zhen Peng, Taoyuan County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/345,441

(22) Filed: Feb. 1, 2006

(30) Foreign Application Priority Data
Feb. 2, 2005 (TW) 94103188

(51) Int. Cl. H01R 12/24

(52) U.S. Cl. 439/492

(57) ABSTRACT

An electronic device including a panel, an interface board, a flexible flat cable, and a pad. The panel includes a first connector. The interface board includes a second connector that does not oppositely face the first connector. The flexible flat cable connects the first connector and the second connector, and includes a bend portion. The pad is disposed in the bend portion.

### BACKGROUND

The invention relates to an electronic device and a flexible flat cable assembly thereof, and in particular, to a flexible flat cable assembly with stable transmission.

Referring to FIG. 1a, in an electronic device 10, a flexible flat cable 13 is typically utilized to transmit signals between, for example, a panel 11 and an interface board 12. Since the electronic device 10 comprises numerous components therein, a connector 11a of the panel 11 may not oppositely face a connector 12a of the interface board 12 due to arrangement of other components. In this circumstance, the flexible flat cable 13 must be bent once or twice (or more times) to form bend portions 13a, thus, the connectors 11a and 12a are connected.

Since the electronic device 10 comprises numerous components therein, the bend portions 13a of the flexible flat cable 13 may be compressed by other components in the electronic device 10. As shown in FIG. 1b, the flexible flat cable 13 follows the contour of the bend portion 13a to form a bend with 180 degrees, thus, the transmission of the flexible flat cable 13 is affected. Specifically, the impedance of the flexible flat cable 13 with the bend portion 13a as shown in FIG. 1b is lower than that of a flexible flat cable without the bend portion. Also, the transmission thereof becomes unstable, and does not meet specified requirement.

### SUMMARY

Electronic devices are provided. An exemplary embodiment of an electronic device comprises a panel, an interface board, a flexible flat cable, and a pad. The panel comprises a first connector. The interface board comprises a second connector that does not oppositely face the first connector. The flexible flat cable connects the first connector and the second connector, and comprises a bend portion. The pad is disposed in the bend portion.

Furthermore, the pad may be made of insulating materials, such as foam. Note that the thickness of the pad is not less than 0.1 mm.

Flexible flat cable assemblies are provided. An exemplary embodiment of a flexible flat cable assembly comprises a flexible flat cable and a pad disposed on the flexible flat cable.

Moreover, the flexible flat cable comprises two surfaces, and the pad fully covers on one of the surfaces.

Another exemplary embodiment of an electronic device comprises a first board, a second board, a flexible flat cable, and a pad. The first board comprises a first connector. The second board comprises a second connector that does not oppositely face the first connector. The flexible flat cable connects the first connector and the second connector, and comprises a bend portion. The pad is disposed in the bend portion.

### DESCRIPTION OF THE DRAWINGS

The invention can be more fully understood by reading the subsequent detailed description and examples with references made to the accompanying drawings, wherein:

FIG. 1a is a schematic view of a conventional electronic device;

FIG. 1b is a schematic view of a bend portion of a conventional flexible flat cable;

FIG. 2a is a schematic view of an embodiment of an electronic device;

FIG. 2b is a schematic view of an embodiment of a flexible flat cable;

FIG. 3 is a schematic view of another embodiment of a flexible flat cable;

FIG. 4a is a chart depicting an experimental result of the conventional flexible flat cable; and

FIG. 4b is a chart depicting an experimental result of the flexible flat cable assembly in FIG. 2b.

### DETAILED DESCRIPTION

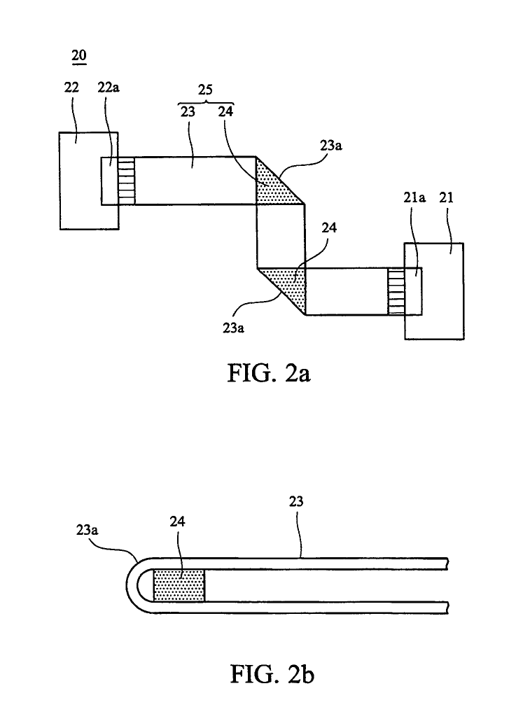

Referring to FIG. 2a, an embodiment of an electronic device 20 comprises a first board 21, a second board 22, a flexible flat cable 23, and two pads 24. The flexible flat cable 23 and the pads 24 constitute a flexible flat cable assembly 25. Furthermore, in this embodiment, the first board 21 is a panel, and the second board 22 is an interface board. That is, in this embodiment, the flexible flat cable assembly 25 connects the panel 21 and the interface board 22. It is not limited to this, however, and may connect other boards requiring connection.

The panel 21 comprises a first connector 21a. The interface board 22 comprises a second connector 22a that does not oppositely face the first connector 21a, as shown in FIG. 2a. The flexible flat cable 23 connects the first connector 21a and the second connector 22a. As shown in FIG. 2a, the flexible flat cable 23 includes two bend portions 23a to properly connect the panel 21 and the interface board 22.

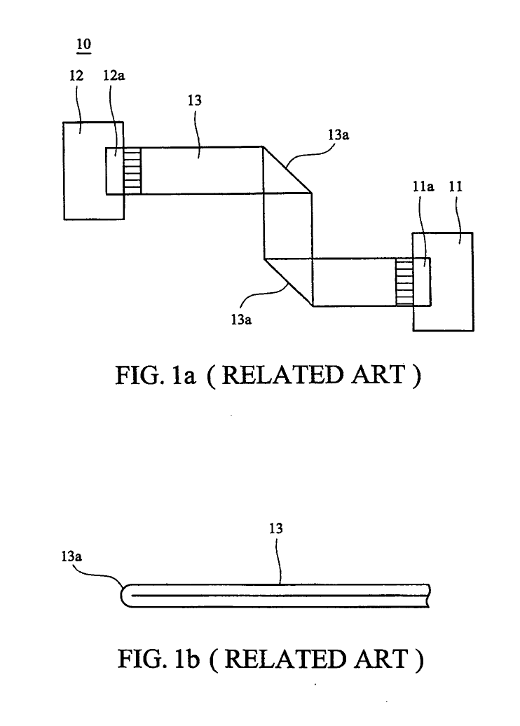

Referring to FIG. 2b, each pad 24 is disposed in the bend portion 23a of the flexible flat cable 23 to smooth the bend portion 23a. Thus, unlike the conventional flexible flat cable 13 as shown in FIG. 1b, the flexible flat cable 23 does not closely follow the contour of the bend portion 23a.

Furthermore, the pad 24 may be made of insulating materials, such as foam. Note that the thickness of the pad 24 is preferably not less than 0.1 mm. Additionally, it is not necessary to place the pad 24 on every bend portion 23. Specifically, since the transmission of the flexible flat cable 23 is mainly affected by the bend portion 23a nearest the panel 21, the pad 24 may be simply disposed in the bend portion 23a nearest the panel 21.

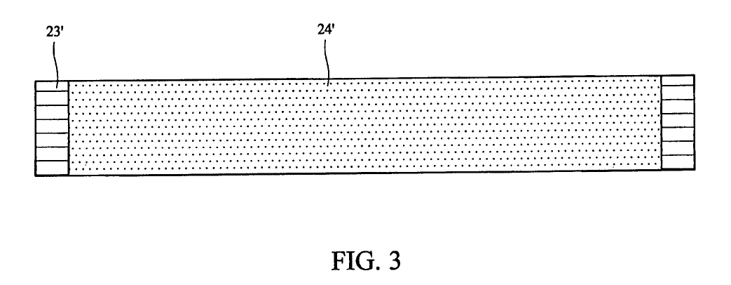

Furthermore, the position of the pad 24 is not limited to the position as shown in FIG. 2b. For example, as shown in FIG. 3, the pad 24′ fully covers on a surface of the flexible flat cable 23′. Thus, the flexible flat cable assembly 25′ can be bent at any position needed. In view of cost, the pad may be disposed on both surfaces of the flexible flat cable, or one of the surfaces thereof.

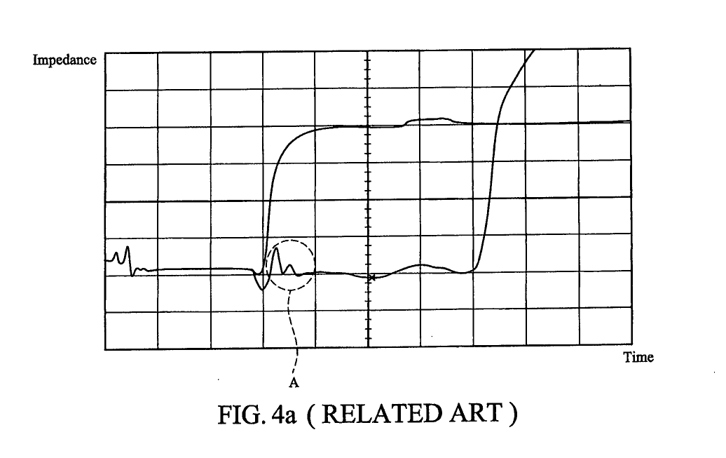

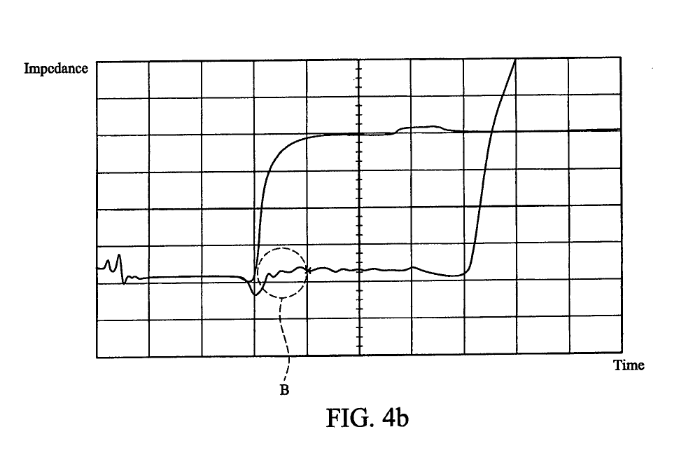

FIG. 4a is a chart depicting an experimental result of the conventional flexible flat cable. FIG. 4b is a chart depicting an experimental result of the flexible flat cable assembly in FIG. 2b. In FIG. 4a, the variation of the impedance of the flexible flat cable 13 is greater, and the curve line thereof is unstable. Conversely, in FIG. 4b, the variation of the impedance of the flexible flat cable 23 is lower, and the curve line thereof is relatively stable. Specifically, the curve line in a portion B of FIG. 4b is more stable compared with the curve line in a corresponding portion A of FIG. 4a. Additionally, the standard value of the impedance of the flexible flat cable at a predetermined time is, for example, 100 ohms. At the predetermined time, the measured value of the impedance of the conventional flexible flat cable 13 is 92.3306 ohms, and the measured value of the impedance of the flexible flat cable 23 in this embodiment is 101.546 ohms. Thus, the impedance of the flexible flat cable of the invention is relatively capable of meeting specified requirements, and the transmission thereof is not affected by the bend portion.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device comprising:
a panel comprising a first connector;
an interface board comprising a second connector that does not oppositely face the first connector;
a flexible flat cable, connecting the first connector and the second connector, comprising a bend portion; and
a pad disposed in the bend portion.

2. The electronic device as claimed in claim 1, wherein the pad is made of insulating materials.

3. The electronic device as claimed in claim 2, wherein the pad is made of foam.

4. The electronic device as claimed in claim 1, wherein the thickness of the pad is not less than 0.1 mm.

5. A flexible flat cable assembly comprising:
a flexible flat cable; and
a pad disposed on the flexible flat cable.

6. The flexible flat cable assembly as claimed in claim 5, wherein the flexible flat cable comprises a bend portion in which the pad is disposed.

7. The flexible flat cable assembly as claimed in claim 5, wherein the flexible flat cable comprises two surfaces, and the pad fully covers on one of the surfaces.

8. The flexible flat cable assembly as claimed in claim 5, wherein the pad is made of insulating materials.

9. The flexible flat cable assembly as claimed in claim 8, wherein the pad is made of foam.

10. The flexible flat cable assembly as claimed in claim 5, wherein the thickness of the pad is not less than 0.1 mm.

11. An electronic device comprising:
a first board comprising a first connector;
a second board comprising a second connector that does not oppositely face the first connector;
a flexible flat cable, connecting the first connector and the second connector, including a bend portion; and
a pad disposed in the bend portion.

12. The electronic device as claimed in claim 11, wherein the pad is made of insulating materials.

13. The electronic device as claimed in claim 12, wherein the pad is made of foam.

14. The electronic device as claimed in claim 11, wherein the thickness of the pad is not less than 0.1 mm.
